(19) United States
(12) Patent Application Publication
(10) Pub. No.: US 2021/0235025 A1
(43) Pub. Date: Jul. 29, 2021

(54) INFORMATION PROCESSING APPARATUS, INFORMATION PROCESSING METHOD AND INFORMATION PROCESSING SYSTEM

(71) Applicant: TOYOTA JIDOSHA KABUSHIKI KAISHA, Toyota-shi (JP)

(72) Inventors: Kentaro TAKAHASHI, Toyota-shi (JP); Hirotaka SUNADA, Nagoya-shi (JP); Hideo HASEGAWA, Nagoya-shi (JP); Naomi KONDO, Toyota-shi (JP); Takashi SHIOMI, Nisshin-shi (JP); Kazuya MIKASHIMA, Nagoya-shi (JP); Jun USAMI, Toyota-shi (JP); Yasuhiko FUKUZUMI, Toyota-shi (JP); Sayaka ISHIKAWA, Miyoshi-shi (JP); Katsuhito YAMAUCHI, Seto-shi (JP); Tasuku KUNO, Toyota-shi (JP)

(73) Assignee: TOYOTA JIDOSHA KABUSHIKI KAISHA, Toyota-shi (JP)

(21) Appl. No.: 17/154,465

(22) Filed: Jan. 21, 2021

(30) Foreign Application Priority Data
Jan. 24, 2020 (JP) 2020-009805

(51) Int. Cl. H04N 5/272; H04N 7/18; G06K 9/00; B60R 1/00; G06Q 30/02

(52) U.S. Cl. CPC H04N 5/2723; H04N 7/18; G06K 9/00791; B60R 1/00; B60R 2300/80; B60R 2300/304; B60R 2300/10; B60R 2300/20; G06Q 30/0266

(57) ABSTRACT

A control unit of an autonomous vehicle, which is a moving object of the present disclosure, acquires a video of the outside of the autonomous vehicle to be displayed on a window display on an inner wall surface of the autonomous vehicle, and superimposes, on the acquired video, an image corresponding to a location of the autonomous vehicle to display on the window display.

### CROSS-REFERENCE TO RELATED APPLICATION

This application claims priority to Japanese Patent Application No. 2020-009805 filed on Jan. 24, 2020, incorporated herein by reference in its entirety.

### BACKGROUND

### 1. Technical Field

The present disclosure relates to an information processing apparatus, an information processing method, and an information processing system, each of which is capable of displaying an image of the outside of a moving object on a display inside the moving object.

### 2. Description of Related Art

In prior art, it has been proposed to project a virtual image on a window of a bus or the like (see, for example, Japanese Unexamined Patent Application Publication No. 2008-108246).

### SUMMARY

Scenery outside a vehicle which is seen from the inside of the vehicle is the real world, and is determined by the place and the time. In general, people traveling in vehicles are merely heading to a destination, and are rarely stimulated by the scenery outside the vehicle during traveling. Therefore, the present disclosure is intended to enable people inside a moving object, such as a car, to be suitably stimulated according to the outside of the moving object.

One aspect of an embodiment of the present disclosure is implemented by an information processing apparatus including a control unit. The control unit acquires a video of the outside of a moving object to be displayed on a window display on an inner wall surface of the moving object, and superimposes, on the acquired video, an image corresponding to the location of the moving object to display on the window display. Another aspect of the embodiment of the present disclosure is implemented by an information processing method executed by at least one computer such as the information processing apparatus. Yet another aspect of the embodiment of the present disclosure is implemented by an information processing system including the information processing apparatus and an information transmission device.

With the information processing apparatus, people in the moving object can be suitably stimulated according to the outside of the moving object.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram of a video display system according to a first embodiment of the present disclosure;

FIG. 2 is a block diagram schematically illustrating a configuration of the system of FIG. 1, particularly illustrating a configuration of an autonomous vehicle;

FIG. 3 is a block diagram schematically illustrating the configuration of the system of FIG. 1, particularly illustrating a configuration of a server device;

FIG. 4 is a block diagram schematically illustrating the configuration of the system of FIG. 1, particularly illustrating a configuration of a user device;

FIG. 5 is a flowchart of an image providing process from the server device to the autonomous vehicle in the system of FIG. 1;

FIG. 6 is a flowchart of an image display process in the autonomous vehicle in the system of FIG. 1;

FIG. 7 is a conceptual diagram of a video display system according to a second embodiment of the present disclosure; and

FIG. 8 is a flowchart of an image display process in the autonomous vehicle in the system of FIG. 7.

### DETAILED DESCRIPTION OF EMBODIMENTS

Hereinafter, an information processing apparatus according to an embodiment of the present disclosure, an information processing method in the information processing apparatus, and a program will be described with reference to drawings.

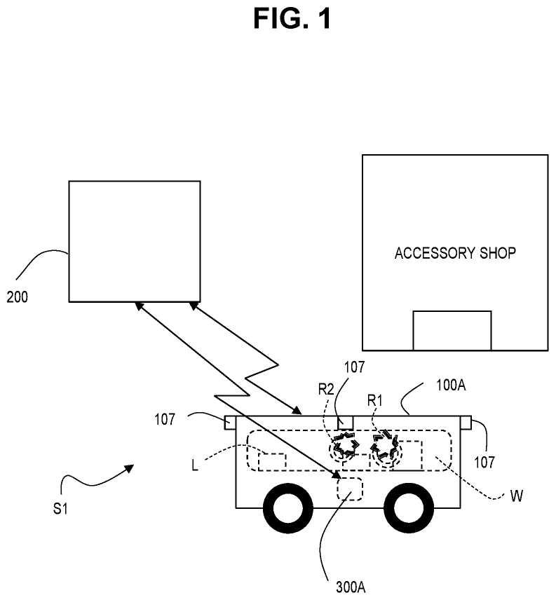

FIG. 1 conceptually illustrates a video display system S1 (also simply referred to as a system S1) according to a first embodiment of the present disclosure. The system S1 includes an autonomous vehicle 100 (100A, . . . ) and a server device 200. The system S1 further includes a user device 300 (300A, . . . ).

The autonomous vehicle 100 is one example of a moving object configured to offer a video display service operated by the system S1. The server device 200 is an information processing apparatus and is a computer on a network N. The server device 200 is configured to communicate with each of the autonomous vehicles 100 via the network N, and to cooperate with an information processing apparatus 102 of the autonomous vehicle 100 via the network N. FIG. 1 illustrates an autonomous vehicle 100A from among a plurality of the autonomous vehicles 100 (100A, . . . ). The number of autonomous vehicles 100 is not limited and may be any number.

The server device 200 can communicate with other server devices via the network N. The server device 200 is configured to communicate with each of the autonomous vehicles 100 via the network N, and also to communicate with each of user devices 300 via the network N.

The user device 300 is configured to communicate with the server device 200 via the network N. Further, the user device 300 is configured to communicate with the autonomous vehicle 100 via the network N. In FIG. 1, a user device 300A is illustrated from among a plurality of the user devices 300 (300A, . . . ). The number of the user devices is not limited and may be any number.

The autonomous vehicle 100 is also called an Electric Vehicle (EV) pallet. The autonomous vehicle 100 is a moving object capable of automatic driving and unmanned driving, and having various sizes. For example, autonomous vehicles 100 of various sizes are available, e.g., a range from small vehicles which only one person can board to large vehicles which dozens of people can board.

The autonomous vehicle 100 has a control function for controlling itself and a communication function. The autonomous vehicle 100 can provide a user with functions and services added by the server device on the network N in addition to a processing that can be executed by the autonomous vehicle 100 alone by cooperating with the server device on the network N. In addition, the autonomous vehicle 100 does not have to be an unmanned vehicle. For example, sales staff, service staff or security staff may board the vehicle. For example, when the service provided by the autonomous vehicle 100 is a food and drink service, chefs or waiters can board the vehicle, and when the service provided by the autonomous vehicle 100 is a childcare service, nursery teachers can board the vehicle. Further, the autonomous vehicle 100 may not necessarily be a vehicle capable of complete autonomous traveling. For example, it may be a vehicle in which a person drives or assists driving depending on a situation. In the first embodiment, the autonomous vehicle 100 is employed as the moving object. However, the moving objects in the system S1 may include a vehicle that cannot run autonomously, that is, a vehicle that requires a driver's operation. In the first embodiment, the autonomous vehicle 100A is configured such that, when a predetermined safety device is activated, autonomous travel is prohibited and only the driver can drive the vehicle.

As described above, the autonomous vehicle 100 is configured to communicate with the user device 300 (300A, . . . ) via the network N. The user device 300 accepts an input from a user and an operation equivalent to such an input, and can communicate not only with the server device 200 but also with the autonomous vehicle 100 via the network N.

The server device 200 is herein mainly a device that issues a service command to the autonomous vehicle 100. For example, the server device 200 transmits, to the autonomous vehicle 100, a service command including a travel plan on when and where a person who desires to board the vehicle, such as a user who desires a service, boards and alights from the vehicle.

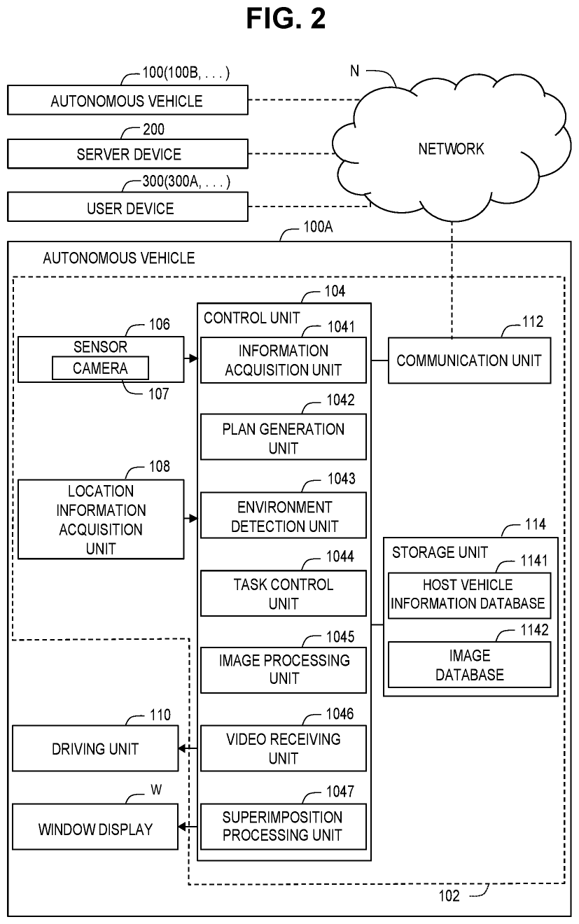

Each component in the system S1 of FIG. 1 will be described in detail hereinbelow. FIG. 2 is a block diagram schematically illustrating a configuration of the system S1 including the autonomous vehicle 100, the server device 200, and the user device 300, in particular, a diagram illustrating a configuration of the autonomous vehicle 100A. In FIG. 2, a configuration of the autonomous vehicle 100A is illustrated as one example of the autonomous vehicle 100. Other autonomous vehicles 100 (100B, . . . ) and the like have the same configuration as that of the autonomous vehicle 100A.

The autonomous vehicle 100A in FIG. 2 is provided with an information processing apparatus 102, and includes a control unit 104 that substantially performs functions thereof. The autonomous vehicle 100A can travel based on the service command acquired from the server device 200. In particular, the autonomous vehicle 100A travels in an appropriate manner based on the service command acquired via the network N while detecting the surroundings of the vehicle. The autonomous vehicle 100A can provide various services to various users while traveling.

The autonomous vehicle 100A further includes a sensor 106, a location information acquisition unit 108, a drive unit 110, a communication unit 112, and a storage unit 114. The autonomous vehicle 100A operates with electric power supplied from a battery.

The sensor 106 is a unit that detects the surroundings of the vehicle. The sensor 106 typically includes a stereo camera, a laser scanner, LIDAR (light detection and ranging, or laser imaging detection and raging), radar, and the like. The information acquired by the sensor 106 is sent to the control unit 104. The sensor 106 includes a sensor that enables a host vehicle to perform autonomous travel. The sensor 106 also includes a camera 107 provided on a body of the autonomous vehicle 100A. For example, the camera 107 may be an image capturing device using an image sensor, such as charged-coupled devices (CCD), metal-oxide-semiconductors (MOS) or complementary metal-oxide-semiconductors (CMOS). An image from an in-vehicle image recording device may be used instead of the image from the camera 107. In the present embodiment, a plurality of cameras 107 is provided at a plurality of points on a vehicle body. Specifically, the cameras 107 may be installed on the front, rear, and left and right sides of the vehicle body, respectively, as illustrated in FIG. 1. There may be cases in which only one camera 107 provided on the vehicle body, such as a camera capable of capturing 360 degrees, is used.

The location information acquisition unit 108 is a unit that obtains a current location of the vehicle, which typically includes a global positioning system (GPS). The information acquired by the location information acquisition unit 108 is sent to the control unit 104. A GPS receiver, as a satellite signal receiver, receives signals from a plurality of GPS satellites. Each GPS satellite is an artificial satellite that orbits the earth. A satellite navigational system, i.e., a navigation satellite system (NSS), is not limited to a GPS. The location information may be detected based on signals from various satellite navigational systems. The NSS is not limited to the global navigation satellite system, but may include a Quasi-Zenith Satellite System, such as “Galileo” in Europe or “Michibiki” in Japan which is integrated with the GPS.

The control unit 104 is a computer that controls the autonomous vehicle 100A based on information acquired from the sensor 106, the location information acquisition unit 108 and the like. The control unit 104 is one example of a control unit that receives the service command from the server device 200 and controls traveling of the autonomous vehicle 100A (moving object) and boarding/alighting of various users.

The control unit 104 includes a CPU and a main storage unit, and executes information processing by a program. The CPU is also called a processor. The main storage unit of the control unit 104 is one example of a main storage device. The CPU in the control unit 104 executes a computer program that is deployed in the main storage unit so as to be executable, and provides various functions. The main storage unit in the control unit 104 stores computer programs executed by the CPU and/or data. The main storage unit in the control unit 104 is a dynamic random access memory (DRAM), a static random access memory (SRAM), a read only memory (ROM), or the like.

The control unit 104 is connected to the storage unit 114. The storage unit 114 is a so-called external storage unit, which is used as a storage area that assists the main storage unit of the control unit 104, and stores computer programs executed by the CPU of the control unit 104, and/or data. The storage unit 114 is a hard disk drive, a solid state drive (SSD), or the like.

The control unit 104 includes an information acquisition unit 1041, a plan generation unit 1042, an environment detection unit 1043, a task control unit 1044, an image processing unit 1045, a video receiving unit 1046, and a superimposition processing unit 1047 as functional modules. Each functional module is implemented by executing, by the control unit 104, that is, the CPU, a program stored in the main storage unit and/or the storage unit 114.

The information acquisition unit 1041 acquires information of, for example, the service command from the server device 200. The service command may include information on a boarding location (a place where the user boards the vehicle), an alighting location (a place where the user alights from the vehicle), a boarding time and an alighting time for a user who desires to use the service provided by the autonomous vehicle 100A or a person who desires to board the autonomous vehicle 100A. Further, the service command may include user information of such a user (for example, a user ID or terminal information of the user device 300 associated with the user). The information acquisition unit 1041 regularly or irregularly acquires information on a host vehicle, for example, boarding status, and stores such information in a host vehicle information database 1141 of the storage unit 114. The information acquisition unit 1041 also acquires information from the user device 300. When the user device 300 of the user U who is in the autonomous vehicle 100A is the user device 300A, the information acquisition unit 1041 can acquire the user ID unique to the user device 300A from the user device 300A.

The plan generation unit 1042 generates a service plan of the host vehicle based on the service command acquired from the server device 200, in particular based on the information of the travel plan included in the service command. Moreover, the service plan generated by the plan generation unit 1042 is sent to the task control unit 1044 to be described below. In the present embodiment, the service plan is data defining a route along which the autonomous vehicle 100A travels and a process to be performed by the autonomous vehicle 100A on a part or the whole of the route. Examples of the data contained in the service plan may include the following.

(1) Data Representing the Route Along which the Host Vehicle Travels as a Set of Road Links

The route along which the host vehicle travels may be automatically generated based on a given departure point and a destination, based on the information of the travel plan included in the service command, with reference to map data stored in the storage unit 114, for example. Alternatively, the route may be generated using an external service.

(2) Data Representing the Process to be Performed by the Host Vehicle at a Point on a Route

The process to be performed by the host vehicle on a route is, for example, but not limited to, “user boarding”, “user alighting” and “provided service”.

The environment detection unit 1043 detects the environment around the vehicle based on the data acquired by the sensor 106. Detection targets include, for example, but are not limited to, the number and positions of lanes, the number and positions of vehicles in the vicinity of the host vehicle, the number and positions of obstacles (pedestrians, bicycles, structures, buildings, and the like) in the vicinity of the host vehicle, road structures, and road signs. Any detection target may be used as long as it is necessary for autonomous traveling. Further, the environment detection unit 1043 may track the detected object. For example, the relative velocity of the object may be obtained from a difference between previous coordinates of the object detected one step before and current coordinates of the object. Data relating to the environment (hereinafter referred to as environment data) detected by the environment detection unit 1043 is sent to the task control unit 1044.

The task control unit 1044 controls operation (traveling) of the host vehicle, which is the moving object, based on the service plan generated by the plan generation unit 1042, the environment data generated by environment detection unit 1043, and the location information of the host vehicle acquired by the location information acquisition unit 108. For example, the host vehicle is directed to travel along a predetermined route such that the obstacle does not enter a predetermined safety area centered around the host vehicle. A well-known method can be adopted as a method for allowing the vehicle to autonomously travel. The task control unit 1044 also executes tasks other than traveling based on the service plan generated by the plan generation unit 1042. Examples of the tasks include boarding and alighting of the user, and issuing a receipt.

The image processing unit 1045 processes an image (i.e., image data) acquired from, for example, the server device 200 via the information acquisition unit 1041. The image processing unit 1045 stores the acquired image data in an image database 1142 of the storage unit 114. The acquired image data is associated with the location information and is stored in the image database 1142 such that the image data can be searched and extracted based on the location information. The storage unit 114 may store a plurality of pieces of image data in advance. In this case, the image processing unit 1045 may associate the image data with the location information such that they are stored together based on the information on the image acquired from the server device 200 (for example, an association list of images corresponding to locations). The information on the image may also be stored in the image database 1142. The image database 1142 may include the image data acquired from the server device 200 and the image data previously stored in the storage unit 114. Further, in the present embodiment, the image data is stored in the image database 1142 such that the image data can be searched and extracted according to the characteristics of the user. The characteristics of the user may include, for example, gender, age, hobbies and preferences. For example, when the characteristics of the user include a category “child”, the image database 1142 is constructed such that the image data falling within the category “child” can be extracted.

The image corresponding to the location of the autonomous vehicle or the information on the image (hereinafter referred to as an image) may be related to a facility such as a shop, or an organization, such as a shopping area, a government office, or a local government office.

The image processing unit 1045 may acquire the image related to the travel plan of the service command from the server device 200 at the same time, or the image corresponding to the location information may be acquired as the autonomous vehicle 100A moves. As the autonomous vehicle 100A moves, the server device 200 can acquire information such as location information of the autonomous vehicle 100 from the autonomous vehicles 100, and provide the image corresponding to the location to the autonomous vehicle 100, to be described below. The process of providing the image, which is carried out as the autonomous vehicle 100 moves, may be carried out automatically or based on a request command from the autonomous vehicle 100. Consequently, since the image corresponding to the location of the autonomous vehicle 100A is acquired as the autonomous vehicle 100A moves, for example, a storage capacity for storing images in the storage unit 114 can be reduced.

The video receiving unit 1046 acquires a video of scenery to be displayed on a window display (hereinafter referred to as a display) W on an inner wall surface of the autonomous vehicle 100A. The video of the scenery outside the autonomous vehicle 100A captured by the camera 107 is displayed on the display W in real time. The display W, which is opaque in the present embodiment, is provided on the inner wall surface of the autonomous vehicle 100A so as to function as a window. The video receiving unit 1046 receives, as data, the image of the scenery that would be seen in the vehicle if the display W were a window. The display W is an electronic window and digitally displays, for example, a video or a combination of a video and an image. The display W may be configured to be opened/closed to the outside of the vehicle. In this case, the display W may be hermetically sealed inside the vehicle when closed.

The superimposition processing unit 1047 executes a process of superimposing, on the video, the image corresponding to the location of the autonomous vehicle 100A, which is the moving object, received by the video receiving unit 1046, and displaying it on the display W. For example, when the autonomous vehicle 100A is traveling on a street where many toy shops are located, it is possible to overlap and display an image for advertising toys on the video displayed on the display W. By displaying the image corresponding to the location of the autonomous vehicle 100A on the realistic video on the window display W, the area where the autonomous vehicle 100A is traveling can be introduced, or products or services that are appealing in such an area can be advertised. The superimposed image can be extracted by searching the image database 1142 based on the location information. However, the superimposed image may be directly acquired from the server device 200 and superimposed on the scenery of the display W. Further, the superimposition processing unit 1047 prohibits superimposing the image corresponding to the location on the video of the display W when a predetermined condition for superimposing the image on the video is not satisfied. The predetermined condition is defined herein as when a predetermined safety device is not operating. However, the predetermined condition is not limited thereto. For example, when the autonomous vehicle 100A is not autonomously traveling, it may be determined that the predetermined condition for superimposing the image on the video is not satisfied.

The drive unit 110 is a unit configured to allow the autonomous vehicle 100A to travel based on a command generated by the task control unit 1044. Examples of the drive unit 110 include a motor for driving wheels, an inverter, a brake, a steering mechanism, and a secondary battery.

The communication unit 112 has a communication unit configured to allow the autonomous vehicle 100A to access the network N. In the present embodiment, the autonomous vehicle 100A can communicate with other devices (for example, the server device 200 and the user device 300A) via the network N. The communication unit 112 may further include a communication unit for inter-vehicle communication between the autonomous vehicle 100A (the host vehicle) and other autonomous vehicles 100 (100B, . . . ).

Next, the server device 200 will be described. The server device 200 is a device that provides information (such as information on various service commands) on a service for each of the plurality of autonomous vehicles 100.

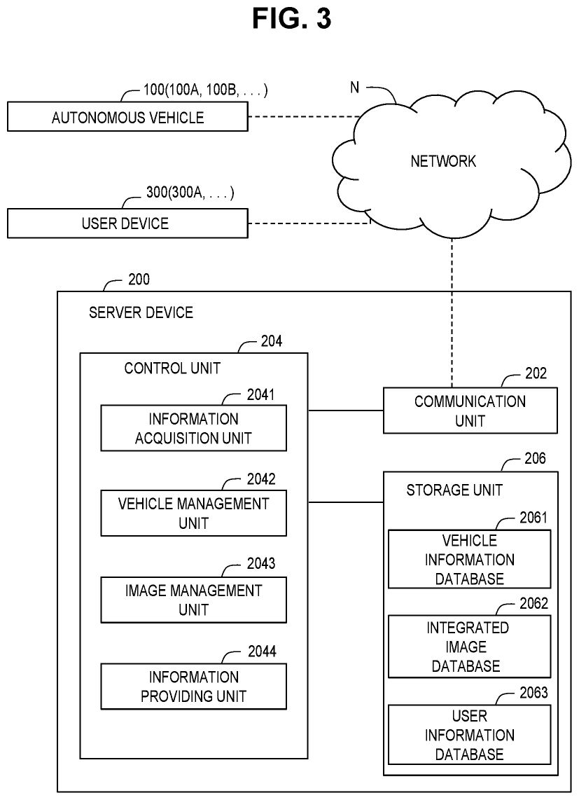

The server device 200 is the information processing apparatus, and includes a communication unit 202, a control unit 204, and a storage unit 206, as illustrated in FIG. 3. The communication unit 202 is the same as the communication unit 112 and has a communication function for connecting the server device 200 to the network N. The communication unit 202 of the server device 200 is a communication interface for communicating with the autonomous vehicle 100 and the user device 300 via the network N. The control unit 204 includes a CPU and a primary storage unit, and executes information processing by a program, similar to the control unit 104. This CPU is also a processor, and the primary storage unit of the control unit 204 is also one example of a primary storage device. The CPU in the control unit 204 executes a computer program that is deployed in the primary storage unit so as to be executable, and provides various functions. The primary storage unit in the control unit 204 stores computer programs executed by the CPU, and/or data. The primary storage unit in the control unit 204 is a DRAM, SRAM, ROM, or the like.

The control unit 204 is connected to the storage unit 206. The storage unit 206 is an external storage unit, which is used as a storage area that assists the primary storage unit of the control unit 204, and stores computer programs executed by the CPU of the control unit 204, and/or data. The storage unit 206 is a hard disk drive, an SSD, or the like.

The control unit 204 is a unit configured to control the server device 200. As illustrated in FIG. 3, the control unit 204 includes, as functional modules, an information acquisition unit 2041, a vehicle management unit 2042, an image management unit 2043, and an information providing unit 2044. Each of these functional modules is implemented by executing, by the CPU of the control unit 204, a program stored in the main storage unit and/or the storage unit 206.

The information acquisition unit 2041 acquires various pieces of information from the autonomous vehicle 100 and the user device 300. The acquired information may be transmitted to, for example, the vehicle management unit 2042. Further, the information acquisition unit 2041 periodically acquires, from the autonomous vehicle 100, location information, information of the host vehicle information database 1141 and the like, and transmits such information to the vehicle management unit 2042. Further, the information acquisition unit 2041 acquires the images, and the like such as image data, related to the facilities or organizations, such as various stores, and transmits the images to the image management unit 2043.

The vehicle management unit 2042 manages information from the plurality of autonomous vehicles 100 under management. In particular, the vehicle management unit 2042 receives information, such as data related to the autonomous vehicle 100, from the plurality of autonomous vehicles 100 via the information acquisition unit 2041 and stores such information in a vehicle information database 2061 of the storage unit 206 at predetermined intervals. The location information and the vehicle information are used as information on the autonomous vehicle 100. Examples of the vehicle information include identifier, usage/type, information on a stand-by point (a garage or a sales office), a door type, a vehicle body size, a luggage compartment size, loading capacity, distance that can be traveled when fully charged, current distance that can be traveled, current status, and the like, of the autonomous vehicle 100. However, the vehicle information is not be limited thereto. The current status includes information such as the user's boarding status and provided service status.

The image management unit 2043 stores the images, and the like acquired via the information acquisition unit 2041 (for example, the image data) in an integrated image database 2062 of the storage unit 206. The acquired image data is stored such that the image data can be searched based on the location information. The integrated image database 2062 and the image database 1142 may be the same, but are different in the present embodiment. Herein, the integrated image database 2062 stores the image data of a managing area (that is, the entire area), but the image database 1142 only stores the image data of a part of the area in the present embodiment.

The information providing unit 2044 provides each autonomous vehicle 100 with information on various service commands according to a predetermined program. A schedule for when the user associated with the user device 300 boards the autonomous vehicle 100 is generated based on the information acquired by the information acquisition unit 2041, and the service command for the autonomous vehicle 100 is generated. The information providing unit 2044 can refer to the map information database in the storage unit 206 to generate the service command. The information providing unit 2044 further extracts, for each autonomous vehicle 100, an image suitable for the autonomous vehicle 100 from the integrated image database 2062 and transmits the image to the autonomous vehicle 100. The provided image is related to an area where the autonomous vehicle 100 may travel based on the service command. The image is provided to the autonomous vehicle 100 separately or together with the information on the service command of the autonomous vehicle 100.

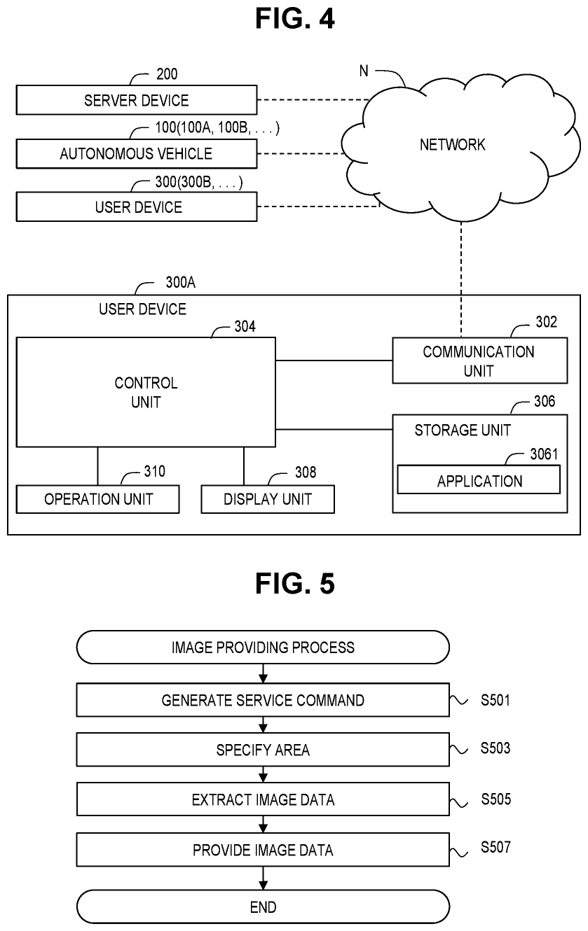

Next, the user device 300 will be described hereinbelow. Examples of the user device 300 include a mobile terminal, a smartphone, and a personal computer. The user device 300A illustrated in FIG. 4, as an example, has a communication unit 302, a control unit 304, and a storage unit 306. The communication unit 302 and the storage unit 306 of the user device 300A are the same as the communication unit 202 and the storage unit 206 of the server device 200, respectively. Furthermore, the user device 300A includes a display unit 308 and an operation unit 310. The display unit 308 may be, for example, a liquid crystal display or an electroluminescence panel. Examples of the operation unit 310 may include a keyboard and a pointing device. More specifically, in the present embodiment, the operation unit 310 includes a touch panel, and is substantially integrated with the display unit 308.

The control unit 304 includes a CPU and a main storage unit, similar to the control unit 204 of the server device 200. The CPU of the control unit 304 executes an application program (hereinafter referred to as application) 3061 stored in the storage unit 306. The application 3061 is an application program for accessing information distributed from a web browser or the server device 200. The application 3061 has a GUI, accepts an input by the user (for example, access), and transmits the input to the autonomous vehicle 100 or the server device 200 via the network N. The user can confirm service schedule information of the autonomous vehicle 100 and input the service of the autonomous vehicle 100 that the user desires to use, via the user device 300. This input is transmitted from the user device 300A to the server device 200, but may be transmitted to the autonomous vehicle 100.

Moreover, in FIGS. 2, 3, and 4, the autonomous vehicle 100, the server device 200 and the user device 300 are connected by the same network N. However, this connection may be implemented by a plurality of networks. For example, a network that connects the autonomous vehicle 100 to the server device 200 may differ from a network that connects the server device 200 to the user device 300.

A process in the system S1 having the configuration described above will be described hereinbelow. A process of providing the images, and the like (for example, image data) from the server device 200 to the autonomous vehicle 100A, will be described with reference to FIG. 5.

The information providing unit 2044 of the server device 200 generates the service command for each autonomous vehicle 100 (step S501). The information providing unit 2044 identifies the area where the autonomous vehicle 100 may travel based on the information on the travel plan of the service command for each autonomous vehicle 100 (step S503).

The information providing unit 2044 of the server device 200 searches the integrated image database 2062 stored in the storage unit 206 based on the information about the location, that is, the specified area, and extracts the images, and the like (such as image data) related to the area (step S505). The extracted image data is transmitted, that is, provided, by the information providing unit 2044 to the autonomous vehicle 100 together with the service command (step S507).

On the other hand, when transmitting the service command to the autonomous vehicle 100, the server device 200 enables the user device 300 to browse or search for, for example, the planned traveling route and the planned traveling time of the autonomous vehicle 100 via the application 3061. When the information acquisition unit 2041 receives a request from the user device 300, the information providing unit 2044 of the server device 200 transmits information indicating the request of the user device 300 (hereinafter referred to as desired information) to the corresponding autonomous vehicle 100. The transmitted desired information may include the boarding location, the alighting location and/or a desired boarding time. The desired information can include the characteristic information of the user. By searching a user information database 2063 of the storage unit 206 based on the user information, such as a user ID of the user device 300, as well as gender, age, and/or preferences of the user associated with the user device 300, can be extracted. The extracted characteristic information of the user may be provided to the autonomous vehicle 100, or the images and the like, such as image data suitable for the user characteristics, may be extracted and provided to the autonomous vehicle 100.

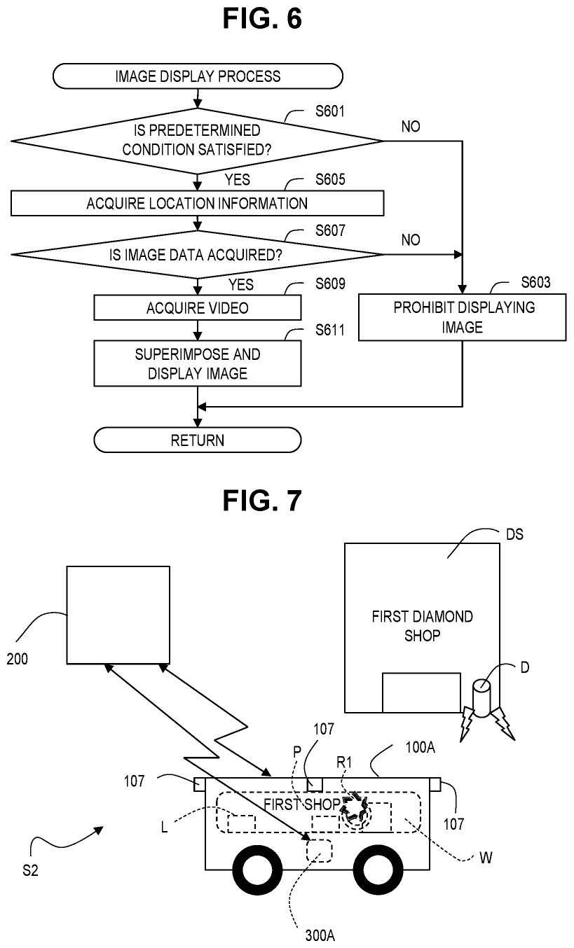

An image display process in the autonomous vehicle 100 will be described with reference to FIG. 6. A routine in the flowchart of FIG. 6 is repeated at predetermined time intervals. The video captured by the camera 107 is processed to be displayed on the display W in real time in each of the autonomous vehicles 100. The process in the autonomous vehicle 100A will be described hereinbelow as an example.

The superimposition processing unit 1047 of the autonomous vehicle 100A determines whether the predetermined condition is satisfied (step S601). The predetermined condition is that the predetermined safety device is not operating. The predetermined safety device operates when an emergency button is pressed by the user or a deviation that is within a predetermined range from the planned traveling route is detected. When the predetermined condition is not satisfied (NO in step S601), the superimposition processing unit 1047 prohibits superimposing, on the video, the image corresponding to the location of the autonomous vehicle 100A of the display W (step S603). Consequently, the video captured by the camera 107 is continuously displayed on the display W in real time. Accordingly, the routine is ended.

On the other hand, when the predetermined condition is satisfied (YES in step S601), the superimposition processing unit 1047 acquires the location information (step S605). The location information is acquired by the location information acquisition unit 108. The location information is acquired as the autonomous vehicle 100 moves. The superimposition processing unit 1047 searches the image database 1142 stored in the storage unit 114 based on this location information. Accordingly, when the image data related to the facility or the organization corresponding to the location cannot be extracted, that is, when the image data cannot be acquired (NO in step S607), the video captured by the camera 107 is continuously displayed on the display W in real time (step S603). Accordingly, the routine is ended. The information on the image described above may be determined to be acquired in step S607.

When the predetermined condition is satisfied (YES in step S601), the image processing unit 1045 may acquire the location information (step S605) and transmit the request command for the image to the server device 200. The image processing unit 1045 may acquire, from the server device 200, the image corresponding to the location of the autonomous vehicle 100A at that time (YES in step S607), and provide the image to the superimposition processing unit 1047.

When the superimposition processing unit 1047 acquires the image data corresponding to the location of the autonomous vehicle 100A (YES in step S607), the superimposition processing unit 1047 acquires the image via the video receiving unit 1046 (step S609). This is for processing such that the image of the acquired image data is displayed so as to be superimposed on the video displayed on the display W. The superimposition processing unit 1047 executes the process of superimposing, on the realistic video acquired outside the vehicle, the image corresponding to the location and displays it on the display W (step S611). In FIG. 1, since the autonomous vehicle is in an area in which there are many accessory shops, images R1 and R2 showing rings are displayed on the display W along with a video L of the scenery outside the vehicle. In FIG. 1, since the display W is inside the vehicle, the display W, the video and the image are represented by dashed lines.

As described above, according to the first embodiment, the image corresponding to the location of the autonomous vehicle 100 is superimposed on the video of the outside of the vehicle which is displayed on the display W of the autonomous vehicle 100. Therefore, it is possible to suitably stimulate according to the outside of the autonomous vehicle 100A through the process by executed the control unit 104 of the information processing apparatus 102 of the autonomous vehicle 100A.

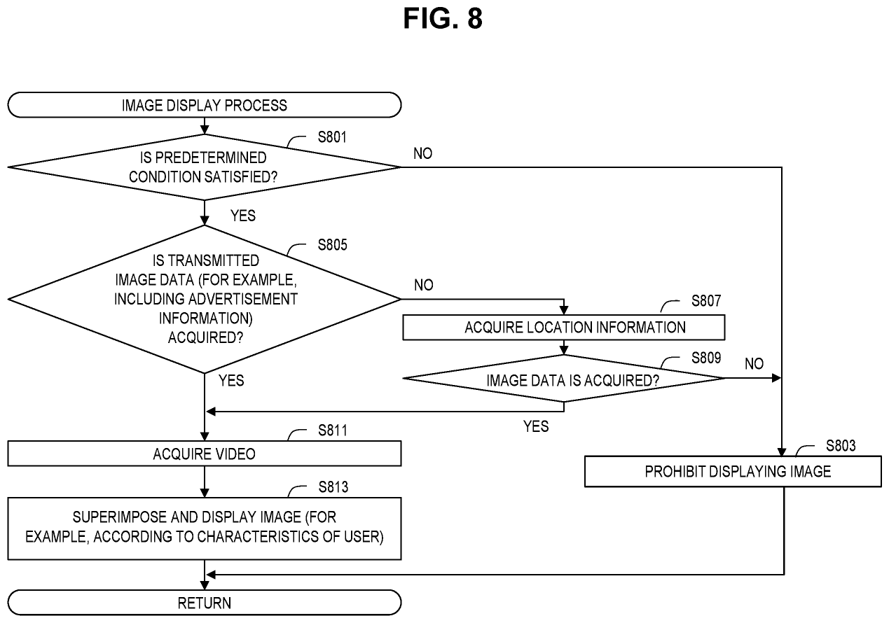

A second embodiment will be described with reference to FIGS. 7 and 8. Hereinbelow, differences from the first embodiment will be described in the second embodiment, and the same descriptions will be omitted.

A video display system S2 of the second embodiment includes an information transmission device D provided in a predetermined area in addition to the configuration of the video display system S1 of the first embodiment. The number of the information transmission devices D is not limited to one, and may be any number. FIG. 7 illustrates the information transmission device D as one example. The control unit 104 of the autonomous vehicle 100 and the information transmission device D execute a process as one example of the information processing system. However, the information processing system may further include the server device 200. Further, the control unit 104 of the autonomous vehicle 100 and the server device 200 may execute a process as one example of an information processing system.

The information transmission device D transmits the image data (hereinafter referred to as transmitted image data) for promotion, such as advertising a specific store or a specific facility located in the predetermined area. The information transmitted by the information transmission device D is not limited to the image, and may be information on the image described above. The communication unit 112 is configured such that the information acquisition unit 1041 of the autonomous vehicle 100 can acquire the transmitted image data from the information transmission device D. The image processing unit 1045 of the autonomous vehicle 100 processes the images and the like, (i.e. image data) acquired from the information transmission device D via the information acquisition unit 1041. That is, the image processing unit 1045 stores the transmitted image data that has been acquired in the image database 1142 of the storage unit 114. In the example of FIG. 7, the information transmission device D is associated with a first diamond shop DS, and is installed at a store of the first diamond shop DS.

The information transmission device D may be, for example, an access point of a wireless local area network (LAN). In the server device 200 according to the first embodiment, the CPU executes a web server program, or the like, installed in the primary storage unit and transmits various types of information through the access point of the wireless LAN. However, the server device 200 may be the information processing apparatus such as a personal computer provided for each area.

The information transmission device D may have a plurality of access points. The server device 200 has identification information of each access point, location information of each access point, and information indicating a range covered by each access point. The location information may include, for example, the latitude and longitude. The range covered by each access point means, for example, a radius centered on the location of the access point. Therefore, the information transmitted from each access point can be information corresponding to the location of each access point. The information transmission device D may be a base station of a mobile phone network. The information transmission device D may use a communication device, such as a dedicated short range communication (DSRC). The information transmission device D may be a terminal of a communication system that transmits information using a network including several ZigBee® terminals.

The image display process in the autonomous vehicle 100A, from among the autonomous vehicles 100, according to the second embodiment will be described with reference to FIG. 8. The following description is made on the assumption that the image has been already provided by the server device 200 described with reference to FIG. 5.

The flowchart of FIG. 8 corresponds to the flowchart of FIG. 6, and steps S801, S803, and steps S807 to S813 correspond to steps S601 to S611 of FIG. 6, respectively.

In the flowchart of FIG. 8, when the predetermined condition is satisfied (YES in step S801), the superimposition processing unit 1047 of the control unit 104 of the autonomous vehicle 100A determines whether the image processing unit 1045 has acquired the transmitted image data. When the image processing unit 1045 can acquire the transmitted image data, the image processing unit 1045 stores the transmitted image data in the image database 1142, similar to the image data described above. The image processing unit 1045 transmits, to the superimposition processing unit 1047, a signal indicating that the transmitted image data has been acquired (hereinafter referred to as an acquired signal). The transmitted image data includes advertisement information, image data for advertising for adult males and image data for advertising for adult females, and restriction information on the age and gender of the user. That is, the advertisement information of the transmitted image data changes according to the characteristics of the user. By communicating with the server device 200 based on the user ID from the user device 300A, for example, the autonomous vehicle 100A can specify that the user U boarding the vehicle is an adult (for example, 18 years or older) and is female. When receiving the acquired signal, the superimposition processing unit 1047 searches the image database 1142 based on the characteristics of the user. Consequently, when transmitted image data that matches the user characteristics, or does not depend on the user characteristics, can be acquired (YES in step S805, S811), the superimposition processing unit 1047 proceeds the process to step S813. The superimposition processing unit 1047 displays the transmitted image data that has been acquired on the display W together with the acquired video (step S813). Since the user U who boards the autonomous vehicle 100A is an adult female, the image for advertising to adult females, according to the characteristics of the user, is displayed on the display W together with the video.

The transmitted image data that has been acquired includes the advertisement information of the associated first diamond shop DS. In particular, the transmitted image data that has been acquired includes a “first shop”, which is a title P indicating the first diamond shop DS, an image R1 of a ring for women, and an image of a tie pin for men. As described above, since the user U is an adult female, the “first shop” and the image R1 of the ring for women are displayed on the display W as the image for advertising to adult females (step S813), which is exemplified in FIG. 7.

On the other hand, for example, when the user in the autonomous vehicle 100A is an elementary school student, the superimposition processing unit 1047 cannot acquire transmitted image data that matches the characteristics of the user who is an elementary school student (NO in step S805). Therefore, the superimposition processing unit 1047 acquires the location information (step S807). When the image data based on the location information can be acquired (YES in step S809), the superimposed display is created (steps S811 and S813).

As described above, in the video display system S2 according to the second embodiment, the image transmitted from the information transmission device D positioned in the specific predetermined area as well as the image based on the location information are used as the image corresponding to the location of the autonomous vehicle 100A. The information transmission device D can transmit information suitable for each store or facility. Therefore, it is possible to flexibly switch or set the image to be superimposed and displayed on the video of the display W. Further, since the image transmitted from the information transmission device D includes the advertisement information, the store or facility can be effectively promoted and advertised. Since the advertisement information changes according to the characteristics of the user, the store or facility can be further effectively promoted and advertised.

The advertisement information may also be included in the image data extracted based on the location information. The advertisement information may change according to the characteristics of the user, as described based on the second embodiment.

In the first and second embodiments described above, the processes of receiving the video and superimposing the image are executed by the control unit 104 of the information processing apparatus 102 of the autonomous vehicle 100. However, these processes may be executed by the server device 200. In this case, the server device 200 executes the process (the process of FIG. 6 or FIG. 8) of superimposing the image on the video acquired (i.e. received) via the video receiving unit 1046 of the autonomous vehicle 100. The server device 200 transmits the video superimposed with the image to the information processing apparatus 102 of the autonomous vehicle 100. Consequently, the superimposition processing unit 1047 of the control unit 104, which has acquired the information, may simply stop displaying the video of the camera 107 on the display W and display the video superimposed with the image, which is acquired from the server device 200. Further, the processes of receiving the video and superimposing the image are executed by the information processing apparatus of the autonomous vehicle 100 and the server device 200, which share the roles.

The embodiments described above are mere examples, and the present disclosure can be implemented with appropriate modifications within a range not departing from the scope thereof. The processes and/or units described in the present disclosure can be freely combined and implemented unless technical contradiction occurs.

Further, the processing described as being performed by a single device may be executed in a shared manner by a plurality of devices. For example, the server device 200 (information processing apparatus) and/or the information processing apparatus 102 of the autonomous vehicle 100 do not have to be a single computer, and may be configured as a system including several computers. Alternatively, the processing described as being performed by different devices may be executed by a single device. In the computer system, a hardware configuration (for example, a server configuration) for implementing each function can be flexibly changed.

The present disclosure can also be implemented by supplying a computer program for executing the functions described in the embodiments in a computer, and reading and executing the program by one or more processors included in the computer. Such a computer program may be provided to the computer by a non-transitory computer-readable storage medium connectable to a computer system bus, or may be provided to the computer via the network. Examples of the non-transitory computer-readable storage media include a random disk (such as a magnetic disk (Floppy® disk, a hard disk drive (HDD), and the like) or an optical disk (a CD-ROM, a DVD disk, a Blu-ray disk, and the like)), a read-only memory (ROM), a random access memory (RAM), an EPROM, an EEPROM, a magnetic card, a flash memory, an optical card, and a random type of medium suitable for storing electronic instructions.

What is claimed is:

1. An information processing apparatus, comprising:
a control unit configured to:
acquire a video of an outside of a moving object to be displayed on a window display on an inner wall surface of the moving object; and
superimpose on the acquired video, an image corresponding to a location of the moving object to display on the window display.

2. The information processing apparatus according to claim 1, wherein the control unit is configured to, as the moving object moves, acquire the image related to a facility or an organization corresponding to the location of the moving object, or information on the image.

3. The information processing apparatus according to claim 1, wherein the control unit is configured to, when the moving object is located in a predetermined area, acquire the image or information on the image from an information transmission device provided in the predetermined area.

4. The information processing apparatus according to claim 1, wherein:
the image includes advertisement information; and
the advertisement information is changed according to characteristics of a user who boards the moving object.

5. The information processing apparatus according to claim 1, wherein the control unit is configured to, when a predetermined condition for superimposing the image on the video is not satisfied, prohibit superimposition of the image on the video.

6. An information processing method executed by at least one computer, the information processing method comprising:
acquiring a video of an outside of a moving object to be displayed on a window display on an inner wall surface of the moving object; and
superimposing, on the acquired video, an image corresponding to a location of the moving object to display on the window display.

7. The information processing method according to claim 6, further comprising acquiring, as the moving object moves, the image related to a facility or an organization corresponding to the location of the moving object, or information on the image.

8. The information processing method according to claim 6, further comprising acquiring, when the moving object is located in a predetermined area, the image or information on the image from an information transmission device provided in the predetermined area.

9. The information processing method according to claim 6, wherein:
the image includes advertisement information; and
the advertisement information is changed according to characteristics of a user who boards the moving object.

10. The information processing method according to claim 6, further comprising prohibiting, when a predetermined condition for superimposing the image on the video is not satisfied, superimposition of the image on the video.

11. An information processing system comprising:
an information processing apparatus; and
an information transmission device,
wherein the information processing apparatus includes a control unit configured to:
acquire a video of an outside of a moving object to be displayed on a window display on an inner wall surface of the moving object, and
superimpose, on the acquired video, an image corresponding to a location of the moving object to display on the window display.

12. The information processing system according to claim 11, wherein the control unit is configured to, as the moving object moves, acquire the image related to a facility or an organization corresponding to the location of the moving object, or information on the image.

13. The information processing system according to claim 11, wherein:
the information processing system includes a plurality of information transmission devices provided in different areas; and
the control unit is configured to, when the moving object is located in a predetermined area, acquire the image or information on the image from an information transmission device provided in the predetermined area.

14. The information processing system according to claim 11, wherein:
the image includes advertisement information; and
the control unit is configured to change the advertisement information according to characteristics of a user who boards the moving object and display the changed advertisement information.

15. The information processing system according to claim 11, wherein the control unit is configured to, when a predetermined condition for superimposing the image on the video is not satisfied, prohibit superimposition of the image on the video.
